(19) United States
(12) Patent Application Publication
(10) Pub. No.: US 2017/0067561 A1
(43) Pub. Date: Mar. 9, 2017

(54) Face Seal with Backup Ring

(71) Applicant: Caterpillar Inc., Peoria, IL (US)

(72) Inventors: Sarfraz Alam, Peoria, IL (US); Mark J. Kiesel, Peoria, IL (US)

(73) Assignee: Caterpillar Inc., Peoria, IL (US)

(21) Appl. No.: 15/225,435

(22) Filed: Aug. 1, 2016

Related U.S. Application Data
(60) Provisional application No. 62/214,769, filed on Sep. 4, 2015.

(51) Int. Cl. F16J 15/02; F16J 15/00

(52) U.S. Cl. CPC F16J 15/022; F16J 15/002

(57) ABSTRACT

A face seal includes first and second members which are mounted together, a seal member, and a backup ring. The first member extends along a longitudinal axis and defines an interior cavity. The first and second members each includes a respective sealing surface that extends radially relative to the longitudinal axis. At least one of the sealing surfaces defines an annular groove. The seal member is disposed within the annular groove and is in sealing contact with the sealing surfaces. The backup ring is disposed within the annular groove such that the seal member is radially inward of the backup ring. One sealing surface is movable relative to the other sealing surface in response to increased interior cavity pressure, thereby defining a gap therebetween. The backup ring is interposed between the seal member and the gap such that the backup ring occludes an opening to the gap.

### CROSS-REFERENCE TO RELATED APPLICATIONS

This patent application claims the benefit of U.S. Provisional Patent Application No. 62/214,769, filed Sep. 4, 2015, which is incorporated by reference.

### TECHNICAL FIELD

This patent disclosure relates generally to a face seal and, more particularly, to a face seal for use in high pressure applications.

### BACKGROUND

A face seal includes sealing surfaces that extend in a plane that is normal to the axis of the seal. Face seals are typically used in a static application to prevent leakage in the radial direction with respect to the axis of the seal. Face seals are typically located in a groove or cavity, such as in a flange, of one of the members being sealed together by the face seal.

Normally, the sealing surfaces of the face seal are in abutting relationship to each other and are held in fixed relationship to each other over a range of operating conditions. However, in some applications—such as those experiencing cyclic pressure changes, for example—a gap can be periodically defined between the sealing surfaces. When such a condition exists, the seal member may deform sufficiently such that a portion of the seal member is extruded into the gap. When the pressure condition changes and the sealing surfaces return to their abutting relationship, the portion of the seal member extruded into the gap is pinched between the sealing surfaces, leading to the deterioration and/or failure of the seal.

U.S. Pat. No. 7,828,301 is entitled, “Self-Energized Backup Ring for Annular Seals,” and is directed to an apparatus including an annular seal (e.g., an o-ring) and a backup ring to provide support to the annular seal. A gland is provided to accommodate the backup ring and the annular seal. The gland has a contact surface which is adapted to contact a corresponding contact surface of the backup ring upon inserting the backup ring into the gland. The diameters of the contact surfaces of the backup ring and gland are sized such that the contact surface of the backup ring radially interferes with the contact surface of the gland, thereby urging the backup ring out of the gland. A retention mechanism, such as interlocking grooves, protrusions, ridges, notches, slots, or the like may be provided in the backup ring and gland respectively to prevent the backup ring from completely exiting the gland.

There is a continued need in the art to provide additional solutions to enhance the performance of face seals. For example, there is a continued need for a face seal which can accommodate relative axial motion of sealing surfaces without undergoing excessive extrusion conditions.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a face seal that includes a first member, a second member, a seal member, and a backup ring. The first member and the second member are mounted together.

The first member extends along a longitudinal axis and includes a first sealing surface. The first sealing surface extends radially relative to the longitudinal axis. The first member defines an interior cavity. The second member includes a second sealing surface which extends radially relative to the longitudinal axis. The second sealing surface is adjacent to the first sealing surface. At least one of the first sealing surface and the second sealing surface defines an annular groove.

The seal member is annular and has a seal diameter. The seal member is disposed within the annular groove. The seal member is in sealing contact with the first sealing surface and the second sealing surface. The backup ring is annular and has a ring diameter which is larger than the seal diameter. The backup ring is disposed within the annular groove such that the seal member is radially inward of the backup ring.

The second sealing surface is movable relative to the first sealing surface in response to an axial force applied along the longitudinal axis by an interior cavity pressure, thereby defining an axial gap between the first sealing surface and the second sealing surface. The axial gap has an outer gap opening adjacent the annular groove. The backup ring is interposed between the seal member and the outer gap opening of the axial gap such that the backup ring occludes the outer gap opening.

In yet another embodiment, a backup ring for a face seal includes an inner cylindrical sidewall and an end. The inner cylindrical sidewall is cylindrical. The inner cylindrical sidewall extends along, and circumscribes a longitudinal axis. The end adjoins the inner cylindrical sidewall. The end has a tapered end surface which is annular. The tapered end surface defines an oblique angle with respect to a radial plane which is perpendicular to the longitudinal axis.

In still another embodiment, a backup ring for a face seal includes a sidewall, an end, and a tapered surface. The sidewall is cylindrical and includes an end edge and a taper edge. The sidewall extends between the end edge and the taper edge along a longitudinal axis, and the sidewall circumscribes the longitudinal axis. The end is annular and includes a sidewall edge and a radial edge in spaced radial relationship to the sidewall edge. The sidewall edge of the end adjoins the end edge of the sidewall. The tapered surface extends from the radial edge of the end radially and longitudinally toward the taper edge of the sidewall.

Further and alternative aspects and features of the disclosed principles will be appreciated from the following detailed description and the accompanying drawings. As will be appreciated, the principles related to face seals and backup rings disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is an elevational view, partially in section, of an embodiment of a hydraulic actuator which includes an embodiment of a face seal constructed according to principles of the present disclosure.

FIG. 2 is an enlarged, detail view, in longitudinal section, of an end of the hydraulic actuator of FIG. 1, illustrating an end cap removed from a tube thereof and the face seal of FIG. 1 with a seal member and an embodiment of a backup ring constructed according to principles of the present disclosure in an uninstalled condition.

FIG. 3 is an enlarged detail view, in longitudinal section and as indicate by circle III in FIG. 2, of a seal cavity formed between an end of a tube and an end cap of the hydraulic actuator of FIG. 1, illustrating the face seal of FIG. 2 in an installed condition.

FIG. 4 is a view as in FIG. 3, illustrating the face seal undergoing cyclic pressure.

FIG. 5 is a top plan view of the backup ring of FIG. 2.

FIG. 6 is a cross-sectional view of the backup ring of FIG. 5 taken along line VI-VI in FIG. 5.

FIG. 7 is a cross-sectional view, as in FIG. 6, of another embodiment of a backup ring constructed according to principles of the present disclosure taken along line VII-VII in FIG. 5.

FIG. 8 is a view, similar to FIG. 3, of another embodiment of a face seal constructed according to principles of the present disclosure that includes the backup ring of FIG. 7, illustrating the backup ring and a seal member in an uninstalled condition.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

The present disclosure provides embodiments of a face seal with a seal member and a backup ring. In embodiments, a face seal constructed in accordance with principles of the present disclosure can be incorporated into any suitable machine. Examples of such machines include mobile or fixed machines used for construction, farming, mining, forestry, transportation, and other similar industries. In some embodiments, the machine can be an excavator, tractor, wheel loader, backhoe, crane, compactor, dozer, wheel tractor-scraper, material-handling machine, or any other suitable machine which includes a face seal.

Embodiments of a face seal constructed according to principles of the present disclosure can have a seal member and a backup ring made from an elastomeric material that is sufficiently elastic to accommodate relative axial movement between sealing surfaces (such as, an annular groove in an end of a cylinder and a mating cover, for example) while occluding any axial gap defined therebetween. In embodiments, the tapered backup ring is made from a material that has a modulus of elasticity that is higher than the material from which the seal member is made. In embodiments, the backup ring is tapered such that the axial force necessary to bring the sealing surfaces into abutting relationship during assembly of the parts is reduced relative to a non-tapered configuration.

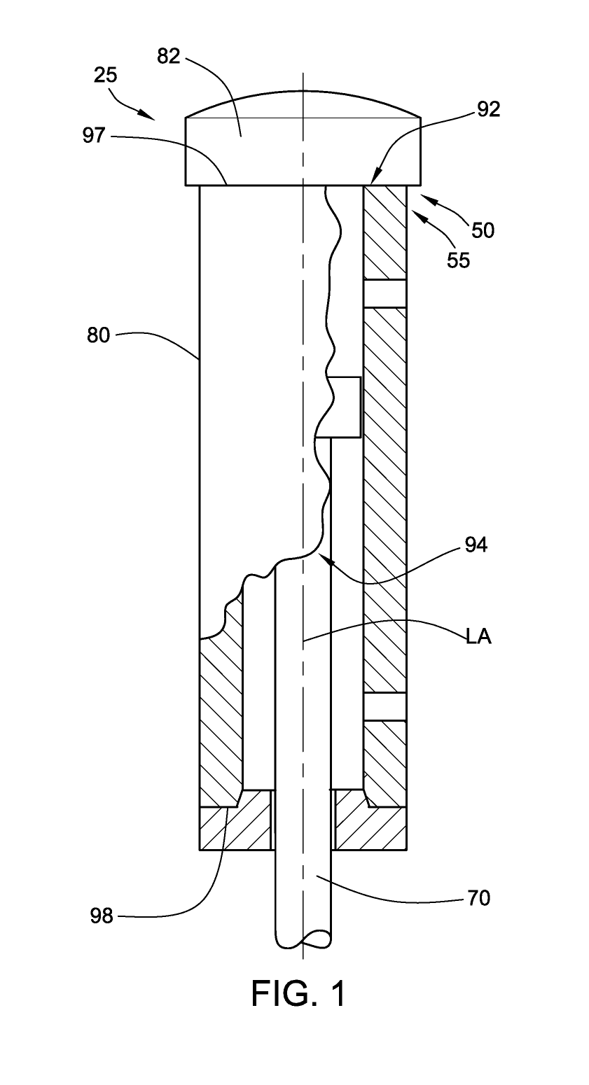

Turning now to the FIGURES, there is shown in FIG. 1 an exemplary embodiment of a hydraulic actuator 25 which can incorporate therein an embodiment of a face seal 50 constructed according to principles of the present disclosure. The hydraulic actuator 25 includes a cylinder 55 and a piston 70 housed within the cylinder 55 such that the piston 70 extends from the cylinder 55. The piston 70 is reciprocally movable over a range of travel between a retracted position and an extended position, as is readily understood by one skilled in the art. The hydraulic actuator 25 can be placed in fluid communication with a source of hydraulic fluid and suitably configured to selectively move the piston 70 over its range of travel.

In embodiments, the pressure in the cylinder 55 of the hydraulic actuator 25 is very high in order to move the piston 70 to the extended position, particularly when the piston 70 is used to produce a working force in an implement, for example. As such, the pressure in the cylinder 55 changes cyclically as the piston 70 is reciprocally moved over its range of travel between the retracted position and the extended position.

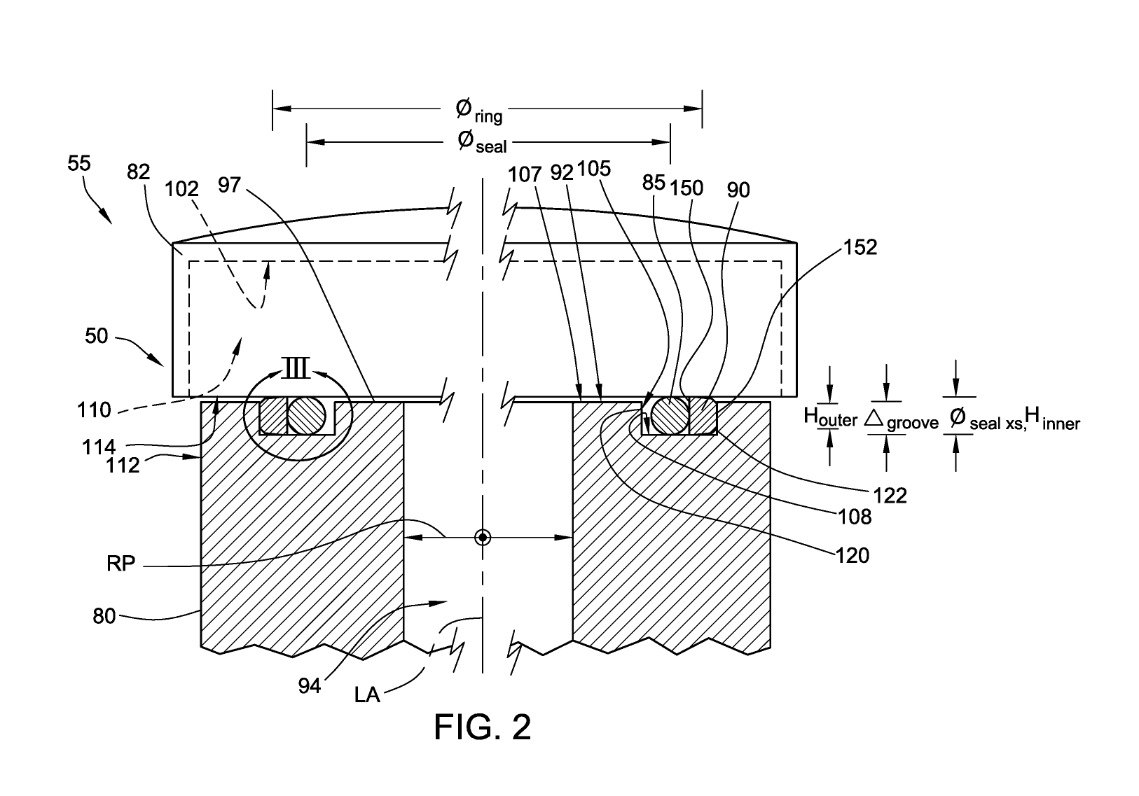

Referring to FIGS. 1 and 2, the cylinder 55 of the hydraulic actuator 25 of FIG. 1 can incorporate therein the face seal 50 constructed according to principles of the present disclosure. The cylinder 55 includes a first member in the form of a tube 80 and a second member in the form of an end cap 82. The face seal 50 includes the first member 80, the second member 82, a seal member 85, and a backup ring 90 constructed according to principles of the present disclosure. In other embodiments, a face seal constructed according to principles of the present disclosure can use other forms of first and second members, as will be appreciated by one skilled in the art.

The first and second members 80, 82 can be made from any suitable material, such as metal, for example. In embodiments, the first member 80 extends along a longitudinal axis LA and includes a first sealing surface 92. The first sealing surface 92 extends radially relative to the longitudinal axis LA. The first member 80 defines an interior cavity 94.

In the illustrated embodiment, the first member 80 is in the form of the tube and has an end 97 which is annular. The end 97 of the tube 80 is configured to facilitate the mounting of the second member 82 thereto. The first sealing surface 92 is disposed at the end 97 and extends along a radial plane RP that is perpendicular to the longitudinal axis LA (see FIG. 2). The interior cavity 94 is disposed radially within the first sealing surface 92.

The interior cavity 94 can be placed in hydraulic communication with a supply of hydraulic fluid configured to selectively operate the hydraulic actuator 25. In embodiments, the tube 80 includes an opposing end 98 which can be closed by any suitable arrangement, such as a suitable plug or cover mounted thereto by a plurality of threaded fasteners, for example.

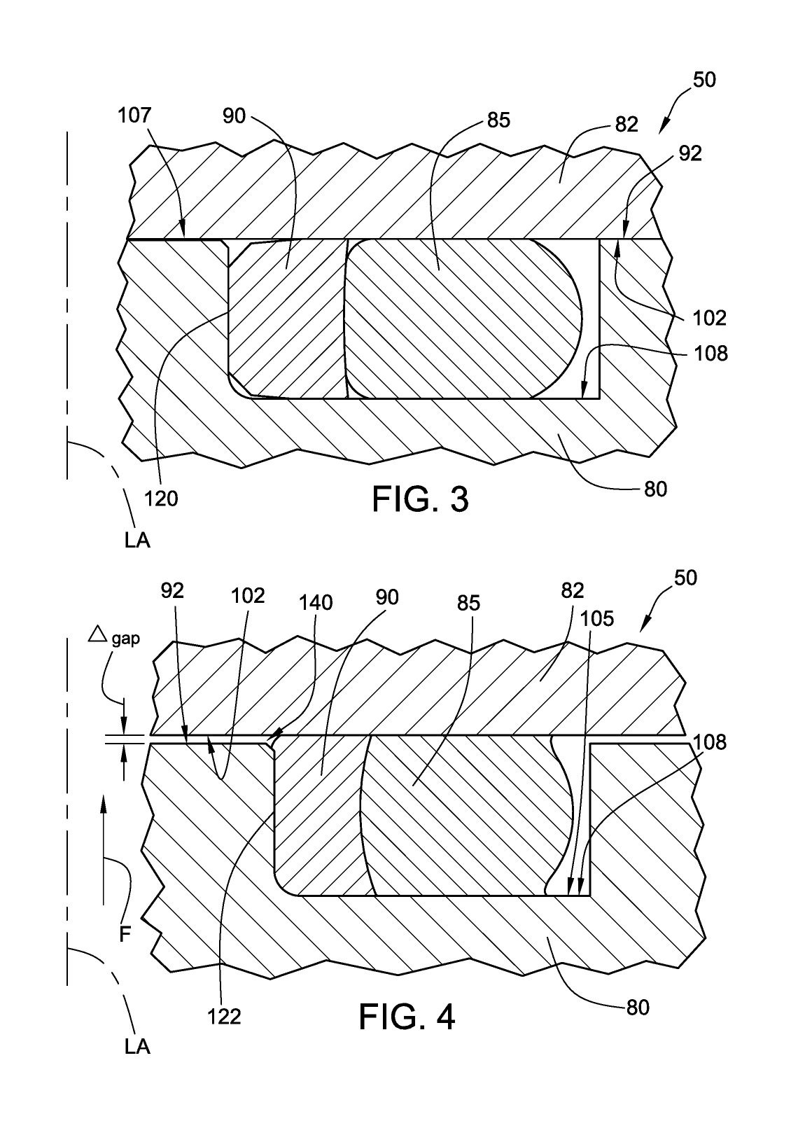

Referring to FIG. 2, the second member 82 includes a second sealing surface 102 which extends radially relative to the longitudinal axis LA. When the second member 82 is mounted to the first member 80, the second sealing surface 102 is adjacent to the first sealing surface (see FIG. 3).

At least one of the first sealing surface 92 and the second sealing surface 102 defines an annular groove 105. In the illustrated embodiment, the first sealing surface 92 of the first member 80 defines the annular groove 105. The annular groove 105 has a groove depth Δ_{groove}, measured along the longitudinal axis LA between a seal face 107 and a groove base 108 of the first sealing surface 92.

Referring to FIGS. 2 and 3, the first member 80 and the second member 82 are mounted together. In the illustrated embodiment, the second member 82 is in the form of the end cap which is configured to be in covering relationship with the end 97 of the first member 80. The second sealing surface 102 of the end cap 82 defines an end cap interior 110. The end cap interior 110 has a shape that is complementary to an exterior surface 112 of the end 97 of the tube 80. In embodiments, any suitable technique can be used to secure the second member 82 to the first member 80 such that the end 97 of the tube 80 is inserted through the interior opening 114 and into the end cap interior 110 so that the second sealing surface 102 of the end cap 82 is seated upon the seal face 107 of the first sealing surface 92 of the tube.

Referring to FIG. 2, the seal member 85 is annular. The seal member 85 is disposed within the annular groove 105 and is coaxial with the longitudinal axis LA of the tube 80. The seal member 85 has a seal diameter Øₛₑₐₗ which is configured such that the seal member is radially disposed within an inner groove sidewall 120 and an outer groove sidewall 122.

In the illustrated embodiment, when the seal member 85 is in an unloaded or uncompressed condition, as shown in FIG. 2, it has a substantially circular cross-sectional shape. In the illustrated embodiment, when in the unloaded—or uncompressed—condition, the seal member 85 maintains the cross-sectional shape shown in FIG. 2 substantially continuously around the entire circumference circumscribed around the longitudinal axis LA by the seal member 85. In the illustrated embodiment, the seal member 85 has a substantially circular cross-sectional shape with a seal cross-sectional diameter Øₛₑₐₗₓₛ that is larger than the groove depth Δ_{groove} when the seal member 85 is in an uncompressed condition.

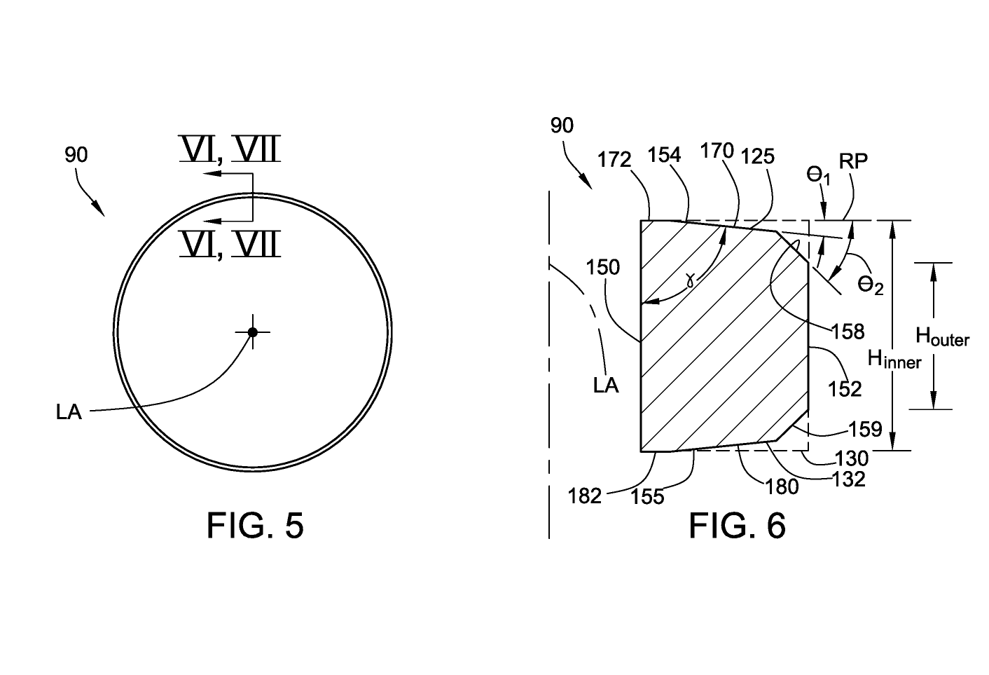

The backup ring 90 is annular. The backup ring 90 has a ring diameter Ø_{ring} which is larger than the seal diameter Øₛₑₐₗ. The backup ring 90 is disposed within the annular groove 105 such that the seal member 85 is radially inward of the backup ring 90. The backup ring 90 is coaxial with the longitudinal axis LA of the tube 80. In the illustrated embodiment, when in the unloaded—or uncompressed—condition, the backup ring 90 maintains the cross-sectional shape shown in FIG. 2 substantially continuously around the entire circumference circumscribed around the longitudinal axis LA by the backup ring 90 (see also, FIGS. 5 and 6).

In embodiments, the seal member 85 is made from a first material with a first modulus of elasticity, and the backup ring 90 is made from a second material with a second modulus of elasticity which are respectively different from the first material and the second modulus of elasticity. In embodiments, the modulus of elasticity of the material from which the backup ring 90 is made is higher than the modulus of elasticity of the material from which the seal member 85 is made. For example, in embodiments, the seal member 85 is made from a suitable elastomeric material, such as a fluoroelastomer, and the backup ring 90 is made from a suitable elastomeric material, such as a thermoplastic polyester elastomer. In embodiments, the backup ring 90 is made from a material which is harder than the material from which the seal member 85 is made.

Referring to FIG. 3, the end cap 82 is mounted to the tube 80. The seal face 107 of the first sealing surface 92 of the first member 80 is in contacting relationship with the second sealing surface 102 of the second member 82. The seal member 85 is in sealing contact with the first sealing surface 92 (at the groove base 108) and the second sealing surface 102. The backup ring 90 also is in contacting relationship with the first sealing surface 92 (at the groove base 108) and the second sealing surface 102. The backup ring 90 is engaged radially with the inner groove sidewall 120.

In embodiments, the backup ring 90 includes at least one tapered surface 125 configured to reduce the assembly force for bringing the second sealing surface 102 into abutting contact with the first sealing surface 92 relative to a backup ring configuration with a rectangular cross-sectional shape 130 circumscribing a cross-sectional shape 132 of the backup ring 90 with the tapered surface 125 (see FIG. 6). Accordingly, the cross-sectional shape 132 of the backup ring 90 is configured to facilitate the assembly of the first and second members 80, 82 by reducing the amount of material that is compressed (relative to the rectangular cross-sectional shape 130 which is non-tapered) to bring the first and second sealing surfaces 92, 102 into abutting relationship.

Referring to FIG. 4, the second sealing surface 102 is movable relative to the first sealing surface 92 in response to an axial force F applied along the longitudinal axis LA by an interior cavity pressure, thereby defining an axial gap Δ_{gap} between the first sealing surface 92 and the second sealing surface 102. Under such conditions, the second sealing surface 102 of the end cap 82 can move axially along the longitudinal axis LA away from the first sealing surface 92 of the tube 80.

The axial gap Δ_{gap} has an outer gap opening 140 adjacent the outer groove sidewall 122 of the annular groove 105. The backup ring 90 is interposed between the seal member 85 and the outer gap opening 140 of the axial gap Δ_{gap} such that the backup ring 90 occludes the outer gap opening 140. In embodiments, the backup ring 90 prevents the seal member 85 from extruding into the seal gap Δ_{gap}. The pressure within the interior cavity 94 urges the seal member 85 radially outwardly against the backup ring 90. The backup ring 90 is compressed radially against the outer groove sidewall 122. The backup ring 90 maintains contacting engagement with both the first sealing surface 92 (over the groove base 108 and the outer groove sidewall 122) and the second sealing surface 102 to occlude the outer gap opening 140. When the pressure in the interior cavity 94 is reduced, the second sealing surface 102 can return to abutting relationship with the first sealing surface 92, as shown in FIG. 3, and the seal member 85 and the backup ring 90 can correspondingly return to the shapes shown in FIG. 3. In this way, the backup ring 90 can help protect the seal member 85 from extruding radially outwardly into the axial gap Δ_{gap} formed between the first and second sealing surfaces 92, 102 as a result of cyclical pressure changes in the interior cavity 94 of the tube 80.

Referring to FIGS. 5 and 6, the backup ring 90 comprises an embodiment of a backup ring constructed according to principles of the present disclosure. The backup ring 90 is annular. In the illustrated embodiment, the backup ring 90 maintains the cross-sectional shape shown in FIG. 6 substantially continuously around the entire circumference circumscribed around the longitudinal axis LA by the backup ring 90.

Referring to FIG. 6, the backup ring 90 includes an inner cylindrical sidewall 150, an outer cylindrical sidewall 152, a first end 154, a second end 155, a first chamfer surface 158, and a second chamfer surface 159. The inner cylindrical sidewall 150 and the outer cylindrical sidewall 152 both extend along, and circumscribe, the longitudinal axis LA. The inner cylindrical sidewall 150 and the outer cylindrical sidewall 152 are in spaced radial relationship to each other. The first end 154 and the second end 155 are in spaced relationship to each other along the longitudinal axis LA and are mirror images of each other. The first chamfer surface 158 extends between the first end 154 and the outer cylindrical sidewall 152, and the second chamfer surface 159 extends between the second end 155 and the outer cylindrical sidewall 152.

The inner cylindrical sidewall 150 has an inner height Hᵢₙₙₑᵣ, measured along the longitudinal axis LA, and the outer cylindrical sidewall 152 has an outer height Hₒᵤₜₑᵣ, measured along the longitudinal axis LA, when in an uncompressed condition. The inner height Hᵢₙₙₑᵣ of the inner cylindrical sidewall 150 is greater than the outer height Hₒᵤₜₑᵣ of the outer cylindrical sidewall 152.

Referring to FIG. 2, in embodiments, the inner height Hᵢₙₙₑᵣ of the inner cylindrical sidewall 150 of the backup ring 90 is greater than the groove depth Δ_{groove} of the annular groove 105. In embodiments, the outer height Hₒᵤₜₑᵣ of the outer cylindrical sidewall 152 of the backup ring 90 is less than the groove depth Δ_{groove}. In embodiments, the inner height Hᵢₙₙₑᵣ of the inner cylindrical sidewall 150 of the backup ring 90 is less than the seal cross-sectional diameter Øₛₑₐₗₓₛ of the seal member 85.

Referring back to FIG. 6, in the illustrated embodiment, the first end 154 includes the tapered surface 125 which comprises a first tapered end surface 170. The first tapered end surface 170 is annular. The first tapered end surface 170 of the first end 154 defines a first taper angle θ₁ with respect to the radial plane RP (which is perpendicular to the longitudinal axis LA) when in an uncompressed condition which comprises an oblique angle. The tapered surface 125 defines a complementary oblique angle γ with respect to the longitudinal axis LA when in an uncompressed condition.

The first end 154 adjoins the inner cylindrical sidewall 150. The first end 154 includes a first base end surface 172 and the first tapered end surface 170. The first base end surface 172 is radially inward of the first tapered end surface 170 and is in adjoining relationship with the inner cylindrical sidewall 150. The first base end surface 172 extends along the radial plane RP and is substantially perpendicular to the longitudinal axis LA when the backup ring 90 is in an uncompressed condition.

The first chamfer surface 158 extends between the first tapered end surface 170 of the first end 154 and the outer cylindrical sidewall 152. The first tapered end surface 170 of the first end 154 is disposed radially within the first chamfer surface 158. The first chamfer surface 158 defines a second taper angle θ₂ with respect to the radial plane RP when in an uncompressed condition. In embodiments, the second taper angle θ₂ is oblique and is different from the first taper angle θ₁.

In embodiments, the first and second taper angles θ₁, θ₂ can be any suitable oblique angle. In the illustrated embodiment, the second taper angle θ₂ is greater than the first taper angle θ₁. In embodiments, the second taper angle θ₂ is at least twice as large as the first taper angle θ₁. In one embodiment, the first taper angle θ₁ is about fifteen degrees, and the second taper angle θ₂ is about forty-five degrees.

The second end 155 and the second chamfer surface 159 are substantially the same as the first end 154 and the first chamfer surface 158, respectively, but mirror images thereof. The second end 155 includes a second tapered end surface 180 and a second base end surface 182. The second tapered end surface 180 is annular. The second base end surface 182 is radially inward of the second tapered end surface 180 and is in adjoining relationship with the inner cylindrical sidewall 150. The first tapered end surface 170 and the second tapered end surface 180 converge toward each other, moving radially outward from the inner cylindrical sidewall 150. The second end 155 and the second chamfer surface 159 are similar in other respects to the first end 154 and the first chamfer surface 158, respectively. In other embodiments, the second end 155 and/or the second chamfer surface 159 can have a configuration that is different from the first end 154 and the first chamfer surface 158, respectively.

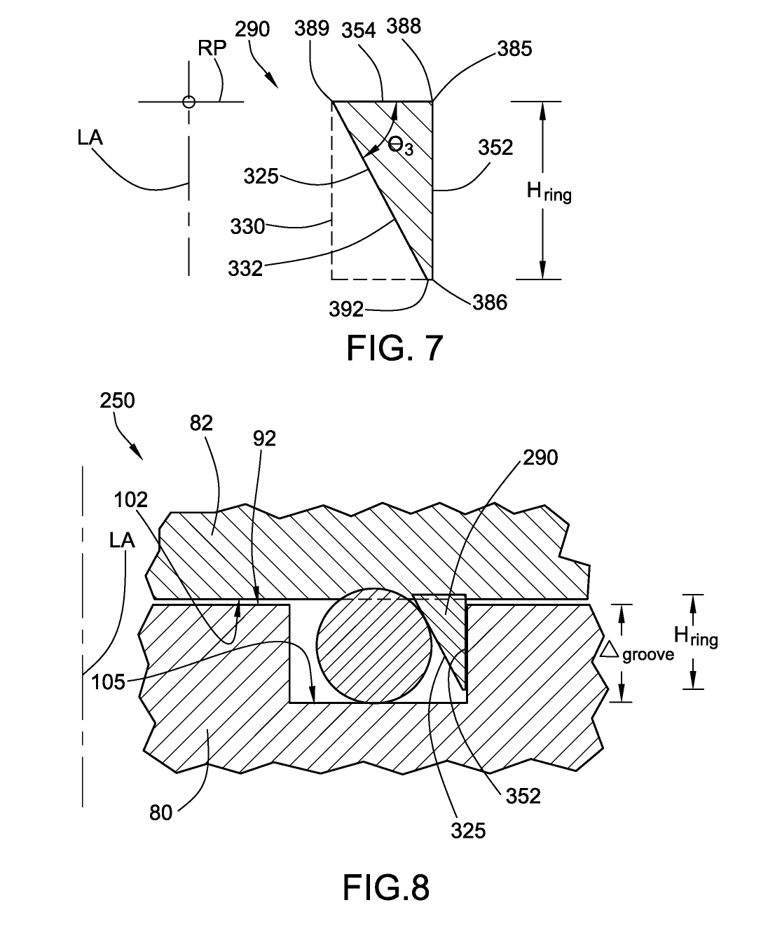

Referring to FIGS. 7 and 8, another embodiment of a backup ring 290 constructed according to principles of the present disclosure is shown therein. The backup ring 290 is suitable for use in embodiments of a face seal 250 constructed according to principles of the present disclosure, such as is shown in FIG. 8. The backup ring 290 is annular, having a shape as shown in FIG. 5. In the illustrated embodiment, the backup ring 290 maintains the cross-sectional shape shown in FIG. 7 substantially continuously around the entire circumference circumscribed around the longitudinal axis LA by the backup ring 290.

The backup ring 290 includes a sidewall 352, an end 354, and a tapered surface 325. The sidewall 352 is cylindrical and includes an end edge 385 and a taper edge 386. The sidewall 352 extends between the end edge 385 and the taper edge 386 along a longitudinal axis LA, and the sidewall 352 circumscribes the longitudinal axis LA. The end 354 is annular and includes a sidewall edge 388 and a radial edge 389 in spaced radial relationship to the sidewall edge 388. The sidewall edge 388 of the end 354 adjoins the end edge 385 of the sidewall 352. The tapered surface 325 extends from the radial edge 389 of the end 354 radially and longitudinally toward the taper edge 386 of the sidewall 352.

In the illustrated embodiment, the sidewall 352 comprises an outer cylindrical sidewall. The end 354 extends between the sidewall edge 388 and the radial edge 389 along the radial plane RP, which is perpendicular to the longitudinal axis LA.

In the illustrated embodiment, the backup ring 290 also includes a tip end 392. The tip end 392 is in spaced relationship to the end 354 along the longitudinal axis LA. The tip end 392 extends radially between the tapered surface 325 and the taper edge 386 of the sidewall 352. The tip end 392 extends along the radial plane RP, which is perpendicular to the longitudinal axis LA.

Referring to FIG. 8, the face seal 250 includes the first member 80, the second member 82, the seal member 85, and the backup ring 290. In embodiments, the tapered surface 325 of the backup ring 290 is configured to reduce the assembly force for bringing the second sealing surface 102 into abutting contact with the first sealing surface 92 relative to a backup ring configuration with a rectangular cross-sectional shape 330 circumscribing a cross-sectional shape 332 of the backup ring 290 with the tapered surface 325 (see FIG. 7). The tapered surface 325 defines a third taper angle θ₃ with respect to the radial plane RP (which is perpendicular to the longitudinal axis LA) when in an uncompressed condition which comprises an oblique angle. In embodiments, the third taper angle θ₃ can be any suitable oblique angle. In embodiments, the third taper angle θ₃ is in a range between about fifteen degrees and about seventy-five degrees. In the illustrated embodiment, the third taper angle θ₃ is about thirty-five degrees.

The outer cylindrical sidewall 352 has a backup ring height H_{ring}, measured along the longitudinal axis LA, when in an uncompressed condition. In the illustrated embodiment, the backup ring height H_{ring} of the backup ring 290 is less than the groove depth of the annular groove 105. The backup ring 290 of FIG. 7 can be similar in other respects to the backup ring 90 of FIGS. 5 and 6. The face seal 250 of FIG. 8 can be similar in other respects to the face seal 50 of FIG. 2.

### INDUSTRIAL APPLICABILITY

The industrial applicability of the embodiments of a face seal described herein will be readily appreciated from the foregoing discussion. At least one embodiment of a face seal constructed according to principles of the present disclosure can be used in a machine to help maintain a seal under cyclic pressure conditions. Embodiments of a face seal according to principles of the present disclosure may find potential application in any suitable machine, such as in use with a hydraulic hammer, demolition shears, etc.

Embodiments of a face seal constructed according to principles of the present disclosure can have a seal member and a backup ring made from an elastomeric material that is sufficiently elastic to accommodate relative axial movement between sealing surfaces while sufficiently stiff to occlude any axial gap defined therebetween and to prevent the seal member from extruding into the axial gap. In embodiments, the backup ring is made from a material that has a modulus of elasticity that is higher than the material from which the seal member is made. In embodiments, the backup ring is tapered such that the axial force necessary to bring the sealing surfaces into abutting relationship during assembly of the parts is reduced relative to a non-tapered configuration.

Embodiments of a face seal constructed according to principles of the present disclosure can be used between sealing surfaces of components subjected to cyclic pressure changes, such as those found in a cylinder of a hydraulic actuator, for example. Increased fluid pressure experienced during a power stroke of the piston can cause the sealing surfaces to move axially apart from each other, defining a gap therebetween. The gap can open and close as the pressure cycles. A face seal constructed according to principles of the present disclosure can be configured to follow the joint motion while maintaining the seal member's sealing contact between the sealing surfaces without undergoing excessive extrusion into the gap. Embodiments of a face seal constructed according to principles of the present disclosure can be used can be used in other applications as will be appreciated by one skilled in the art.

In embodiments, the tapered backup ring is constructed such that the axial assembly force for bringing the sealing surfaces together during the assembly of the components is reduced relative to a non-tapered shape. In embodiments, the tapered backup ring can have different shapes, such as, a triangle or a polygon having at least four sides, for example.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A face seal comprising:
a first member, the first member extending along a longitudinal axis, the first member including a first sealing surface, the first sealing surface extending radially relative to the longitudinal axis, the first member defining an interior cavity;
a second member, the second member and the first member being mounted together, the second member including a second sealing surface, the second sealing surface extending radially relative to the longitudinal axis, the second sealing surface being adjacent to the first sealing surface, at least one of the first sealing surface and the second sealing surface defining an annular groove;
a seal member, the seal member being annular and having a seal diameter, the seal member being disposed within the annular groove, the seal member in sealing contact with the first sealing surface and the second sealing surface;
a backup ring, the backup ring being annular and having a ring diameter, the ring diameter being larger than the seal diameter, the backup ring being disposed within the annular groove such that the seal member is radially inward of the backup ring;
wherein the second sealing surface is movable relative to the first sealing surface in response to an axial force applied along the longitudinal axis by an interior cavity pressure, thereby defining an axial gap between the first sealing surface and the second sealing surface, the axial gap having an outer gap opening adjacent the annular groove, and wherein the backup ring is interposed between the seal member and the outer gap opening of the axial gap such that the backup ring occludes the outer gap opening.

2. The face seal according to claim 1, wherein the annular groove has a groove depth, measured along the longitudinal axis, and the seal member has a substantially circular cross-sectional shape with a seal cross-sectional diameter when the seal member is in an uncompressed condition, the seal cross-sectional diameter being larger than the groove depth.

3. The face seal according to claim 1, wherein the backup ring includes a tapered surface, the tapered surface configured to reduce an assembly force for bringing the second sealing surface into abutting contact with the first sealing surface relative to a backup ring configuration with a rectangular cross-sectional shape circumscribing a cross-sectional shape of the backup ring with the tapered surface.

4. The face seal according to claim 1, wherein the backup ring includes a tapered surface, the tapered surface defining an oblique angle with respect to the longitudinal axis when in an uncompressed condition.

5. The face seal according to claim 4, wherein the seal member is made from a first material with a first modulus of elasticity, and the backup ring is made from a second material with a second modulus of elasticity, the second modulus of elasticity being higher than the first modulus of elasticity.

6. The face seal according to claim 4, wherein the backup ring includes an inner cylindrical sidewall and an end, the end including the tapered surface, the tapered surface comprising a tapered end surface, the tapered end surface being annular, the tapered end surface defining an oblique angle with respect to a radial plane when in an uncompressed condition, the radial plane being perpendicular to the longitudinal axis.

7. The face seal according to claim 6, wherein the backup ring includes an outer cylindrical sidewall and a chamfer surface, the chamfer surface extending between the outer cylindrical sidewall and the tapered end surface, the tapered end surface being disposed radially within the chamfer surface, the tapered end surface defining a first taper angle with respect to the radial plane when in an uncompressed condition, and the chamfer surface defining a second taper angle with respect to the radial plane when in an uncompressed condition, the second taper angle being oblique and being different from the first taper angle.

8. The face seal according to claim 6, wherein the backup ring includes an outer cylindrical sidewall, the inner cylindrical sidewall and the outer cylindrical sidewall in spaced radial relationship to each other, the inner cylindrical sidewall and the outer cylindrical sidewall both extending along, and circumscribing, the longitudinal axis, the inner cylindrical sidewall having a first height, measured along the longitudinal axis, when in an uncompressed condition, and the outer cylindrical sidewall having a second height, measured along the longitudinal axis, when in an uncompressed condition, the first height being greater than the second height.

9. The face seal according to claim 8, wherein the annular groove has a groove depth, measured along the longitudinal axis, the first height of the inner cylindrical sidewall of the backup ring being greater than the groove depth of the annular groove, and the second height of the outer cylindrical sidewall of the backup ring being less than the groove depth.

10. The face seal according to claim 9, wherein the end comprises a first end, the tapered end surface comprises a first tapered end surface, and the backup ring includes a second end having a second tapered end surface, the second end in spaced relationship to the first end along the longitudinal axis, the second tapered end surface being annular, the first tapered end surface and the second tapered end surface converging toward each other moving radially outward from the inner cylindrical sidewall.

11. The face seal according to claim 4, wherein the backup ring includes a sidewall and an end, the end adjoining the sidewall, the sidewall being cylindrical and including an end edge and a taper edge, the sidewall extending between the end edge and the taper edge along the longitudinal axis, the end being annular and including a sidewall edge and a radial edge in spaced radial relationship to the sidewall edge, the sidewall edge of the end adjoining the end edge of the sidewall, and the tapered surface extending from the radial edge of the end radially and longitudinally toward the taper edge of the sidewall.

12. The face seal according to claim 11, wherein the sidewall comprises an outer cylindrical sidewall, and the end extends between the sidewall edge and the radial edge along a radial plane perpendicular to the longitudinal axis.

13. The face seal according to claim 12, wherein the outer cylindrical sidewall has a backup ring height, measured along the longitudinal axis, when in an uncompressed condition, and the annular groove has a groove depth, measured along the longitudinal axis, the backup ring height of the backup ring being less than the groove depth of the annular groove.

14. A backup ring for a face seal, the backup ring comprising:
an inner cylindrical sidewall, the inner cylindrical sidewall being cylindrical, the inner cylindrical sidewall extending along, and circumscribing a longitudinal axis;
an end, the end adjoining the inner cylindrical sidewall, the end having a tapered end surface, the tapered end surface being annular, the tapered end surface defining an oblique angle with respect to a radial plane, the radial plane being perpendicular to the longitudinal axis.

15. The backup ring according to claim 14, further comprising:
an outer cylindrical sidewall; and
a chamfer surface, the chamfer surface extending between the outer cylindrical sidewall and the tapered end surface, the tapered end surface being disposed radially within the chamfer surface, the tapered end surface defining a first taper angle with respect to the radial plane, and the chamfer surface defining a second taper angle with respect to the radial plane, the second taper angle being oblique and being different from the first taper angle.

16. The backup ring according to claim 14, further comprising:
an outer cylindrical sidewall, the inner cylindrical sidewall and the outer cylindrical sidewall in spaced radial relationship to each other, the inner cylindrical sidewall and the outer cylindrical sidewall both extending along, and circumscribing, the longitudinal axis, the inner cylindrical sidewall having a first height, measured along the longitudinal axis, and the outer cylindrical sidewall having a second height, measured along the longitudinal axis, the first height being greater than the second height.

17. The backup ring according to claim 14, wherein the end comprises a first end, and the tapered end surface comprises a first tapered end surface, and the backup ring further comprises:
a second end, the second end adjoining the inner cylindrical sidewall, the second end in spaced relationship to the first end along the longitudinal axis, the second end having a second tapered end surface, the second tapered end surface being annular, the first tapered end surface and the second tapered end surface converging toward each other moving radially outward from the inner cylindrical sidewall.

18. The backup ring according to claim 17, further comprising:
an outer cylindrical sidewall; and
a first chamfer surface, the first chamfer surface extending between the outer cylindrical sidewall and the first tapered end surface, the first tapered end surface being disposed radially within the first chamfer surface, the first tapered end surface defining a first taper angle with respect to the radial plane, and the first chamfer surface defining a second taper angle with respect to the radial plane, the second taper angle being oblique and being different from the first taper angle;
a second chamfer surface, the second chamfer surface extending between the outer cylindrical sidewall and the second tapered end surface.

19. A backup ring for a face seal, the backup ring comprising:
a sidewall, the sidewall being cylindrical and including an end edge and a taper edge, the sidewall extending between the end edge and the taper edge along a longitudinal axis, the sidewall circumscribing the longitudinal axis;
an end, the end being annular and including a sidewall edge and a radial edge, the radial edge in spaced radial relationship to the sidewall edge, the sidewall edge of the end adjoining the end edge of the sidewall; and
a tapered surface, the tapered surface extending from the radial edge of the end radially and longitudinally toward the taper edge of the sidewall.

20. The backup ring according to claim 19, wherein the sidewall comprises an outer cylindrical sidewall, and the end extends between the sidewall edge and the radial edge along a radial plane perpendicular to the longitudinal axis.
